(19) United States
(12) Patent Application Publication
(10) Pub. No.: US 2020/0033628 A1
(43) Pub. Date: Jan. 30, 2020

(54) ROLL-UP AND SNAP-ON EYEWEAR

(71) Applicants: Tyler Hughes, Irvington, NJ (US); Bianca Hughes, Irvington, NJ (US)

(72) Inventors: Tyler Hughes, Irvington, NJ (US); Bianca Hughes, Irvington, NJ (US)

(21) Appl. No.: 16/047,874

(22) Filed: Jul. 27, 2018

(51) Int. Cl. G02C 5/00; G02C 7/12; G02C 3/00

(52) U.S. Cl. CPC G02C 5/006; G02C 3/003; G02C 7/12

(57) ABSTRACT

Embodiments of the disclosure are directed to an eyewear device that is capable of being rolled-up and snapped onto a user's face. The eyewear includes an elongated body comprising a spring portion and a lens portion. The elongated body has at least three states: a straighten state, a coiled state and a partially coiled state. The eyewear is a layered film that is configured to roll into a cylindrical shape. The lens portion of the eyewear is then retained over the eyes of the user in response to the eyewear being attached to the sides of the user. In this regard, the eyewear includes one or more springs that coil immediately when struck against an object. When worn, the natural function of the spring allows the eyewear to be retained at the user's temples. Removing the eyewear allows the film to roll back to its coiled form.

### TECHNICAL FIELD

Embodiments of the disclosure relate generally to eyewear and more specifically, but without limitation, to roll-up and snap-on eyewear.

### BACKGROUND

Eyewear generally comprises a rigid or semi-rigid frame that fits over the eyes for holding a lens or a pair of lenses upon the face in front of the eyes. The eyewear is typically held in place upon the face by rigid or semi-rigid earpieces that fit behind the ears to hold the eyewear on the face. Alternatively, the eyewear may have a band that encircles the head and attaches to the eyewear to hold the eyewear in place on the face.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 is an illustration of an example of an eyewear device in accordance with embodiments of the disclosure.

FIG. 2 is another view of the eyewear device of FIG. 1 in accordance with one embodiment of the disclosure.

FIGS. 3A-3B are perspective views of the eyewear device of FIG. 1 in accordance with one embodiment of the disclosure.

FIGS. 4A-4B depicts different views of a configuration of the eyewear device of FIG. 1 in accordance with one embodiment of the disclosure.

FIGS. 5A-5C depicts different states of the eyewear device of FIG. 1 in accordance with one embodiment of the disclosure.

FIG. 6 depicts another state of the eyewear device of FIG. 1 in accordance with embodiments of the disclosure.

### DETAILED DESCRIPTION

Embodiments of the disclosure provide an article of eyewear that is capable of being rolled and snapped onto a user's face. This eyewear may be configured for several uses, such as for prescription eyewear, shades, 3D polarized lens, etc. In some embodiments, the eyewear may be a layered film that is configured to roll into a cylindrical coiled shape, similar to tape measure. In one embodiment, a user may unroll the eyewear from a coiled state to a flexed or otherwise substantially straighten out state. The eyewear while in a straighten form can be held at one end by a hand and up near the eye region of a user. Afterward, the article of eyewear is pushed or applied against the face of the user causing the eyewear to partial coil around and fixably attach to sides on the user's face.

A lens portion of the eyewear is retained over the eyes of the user in response to the eyewear being attached to the sides of the user's face. For example, the eyewear includes one or more springs that coil immediately when struck against an object, such as the user's face. When the eyewear is worn, the natural function of the spring allows the eyewear to fixably attach to the user's temples. The force of the spring is constant enough to grant full head motion without slipping. Removing the eyewear allows the film to roll back to the initial coiled form. Thus, the rapid removal and reapplication to the user's face is one of the advantages of implementations of the disclosure, which makes eyewear readily available in a comfortable alternative to current forms of eyewear, such as glasses.

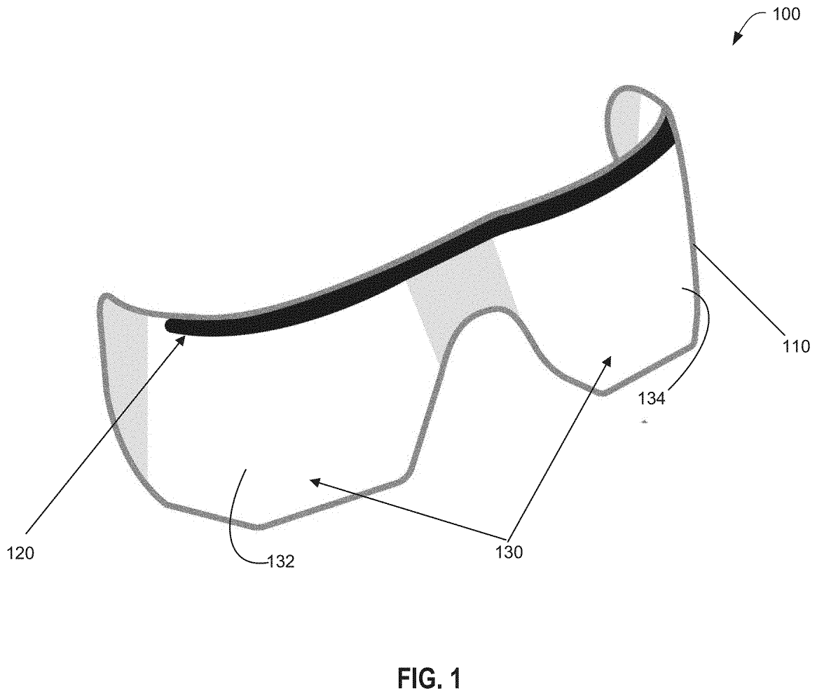

FIG. 1 is an illustration of an example of an eyewear device 100 in accordance with embodiments of the disclosure. As shown, the eyewear device 100 includes an elongated body 110 having one or more springs 120 and a lens portion 130 disposed therein. In some embodiments, the elongated body 110 may be sized in a length to fit around and overlap a user's face. The elongated body 110 may be comprised of a layered flexible material, such as a plastic film. The plastic film can be made by any known film-making technique. In some embodiments, the elongated body 110 may be constructed to have different colors and levels of thickness. For example, the thickness of the elongated body 110 may vary while still allowing the layered flexible material to be coiled and uncoiled into a straightened state.

The one or more springs 120 of the eyewear device 100 can be readily transferred between several states, such as a straight, coiled and partially coiled state (e.g., a curved band). The spring 120 is sized in length to fit around and overlap the user's face. FIG. 1 depicts on example of the spring 120 on the elongated body 110 of the eyewear device 100. The spring 120 can be made of several types of material. In one embodiment, the spring 120 is made of a type of metal spring body or band. Other materials could be used as alternatives to the metal, such as plastic. The spring body has at least three positions of operation or three states of being. The first state is a coiled state. In the coiled state, the spring body is wrapped onto itself such as a tape measure. The second state is a substantially straight or otherwise uncoiled state. In the substantially straight or uncoiled state, the spring body retains potential energy because of the relative position of the spring 120 to the elongated body 110. This potential energy causes the spring 110 to coil immediately when the spring body is struck against an object such as the user's face. The third state is a partially coiled state or shape in the form that the spring body may take when applied around the user's face.

When the eyewear device 100 is applied against the user's face causing the spring 120 to coil, the lens portion 130 is then positioned over an eye region of the user's face. The lens portion 130 is typically permanently attached to the elongated body 110. In some embodiments, the lens portion 130 may be made of a substantially planar sheet of flexible material, such as an optically plastic laminated sheet. The optically plastic laminated sheet may be configured to visual adjust the user's vision when wearing the eyewear device 100. For example, the optically plastic laminated sheet may have various characteristics, such as corrective properties of a conventional reading quality that may correspond to an optically prescription for the user, magnifying type or just a plain (non-reading, non-magnifying) type and may be tinted, permanently or variably, for sun (e.g., ultra-violet light) and glare protection, polarized lamination for 3D video watching as well as other type of properties.

In some embodiments, the lens portion 130 may be split into two portions, such as a first portion 132 and a second portion 134. For example, the first portion 132 is adapted to fit over a first (or right) eye of the user and the second portion 134 is adapted to fit over a second eye (or left) of the user. This configuration of the lens portion 130 may allow for a varied number of uses for the eyewear device 100. In one example, the eyewear device 100 may be used for watching three-dimensional (3D) movies. In such a case, the first portion 132 may be a polarized lamination layer that is different that the second portion 134. For example, the polarized lamination layer is a filter that passes/blocks different waves of light. A 3D movie projector has two adjoined lens with each showing the same image with a slightly different placement on the screen. The different polarization of the lens portion 130 isolates each eye of the user to a certain image using individual polarizers and a quarter wave filter. When viewed simultaneously, the brain superimposes the image and gives the image depth. As such, the eyewear device 100 is polarized with different quarter wave filters in each of the lens portions 132 and 134 to achieve the 3D visual effects of the movie.

To manufacture the eyewear device 100, many techniques can be used. In one example, the lens portion 130 is fabricated as part of the elongated body 110 when the eyewear device 100 is fashioned through a particular manufacture technique. In other manufacture techniques, the lens portion 130 may be fabricated separately and later attached to the elongated body 110 of the eyewear device 100. In one example manufacture technique, a plastic manufacturer supplies the material used to create the eyewear device 100, such as a plastic film or a single layer polymer. Next, a die cutter is used on the material to cutout a shape of the elongated body 110 using a mold. In some embodiments, polarized laminated filters are then cut from a different piece of material to fit over the viewing sections (e.g., lens portion 110) of the eyewear device 100. For example, the polarized laminated filters may be sent to a plastic molding manufacturer where they will sculpt the filters into the desired form. In some embodiments, heat rollers are used to lower the plastic stiffness, which allows the band to coil the plastic more easily. The eyewear device 100 is then cooled into a final shape. This process gives the eyewear device 100 the ability to coil up and to be secured to the user. Thereupon, the spring 120 is attached to the elongated body 110 using a type of adhesive and the eyewear device 100 is then rolled up.

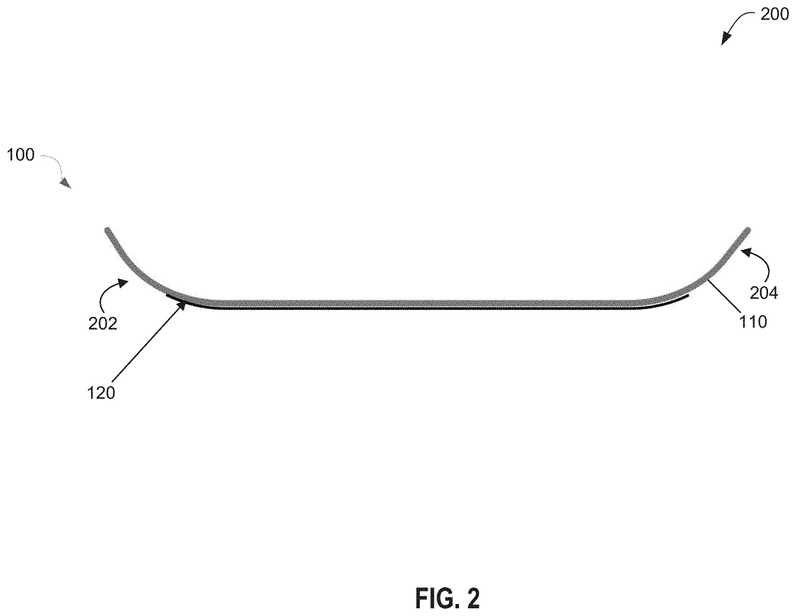

FIG. 2 is another view 300 of the eyewear device 100 of FIG. 1 in accordance with one embodiment of the disclosure. In this example, a top view 200 of the eyewear device 100 is shown. As shown in FIG. 2, the curvature of the elongated body 110 allows the eyewear device 100 to be secured to the user. For example, when the spring 120 is engaged (e.g., by striking the device against a user), this causes the spring 110 to coil immediately to the user. Thereupon, the spring 120 may apply pressure at each side 202 and 204 that keeps the eyewear device 100 in a partially coiled state, such as a curved shape around a user's face.

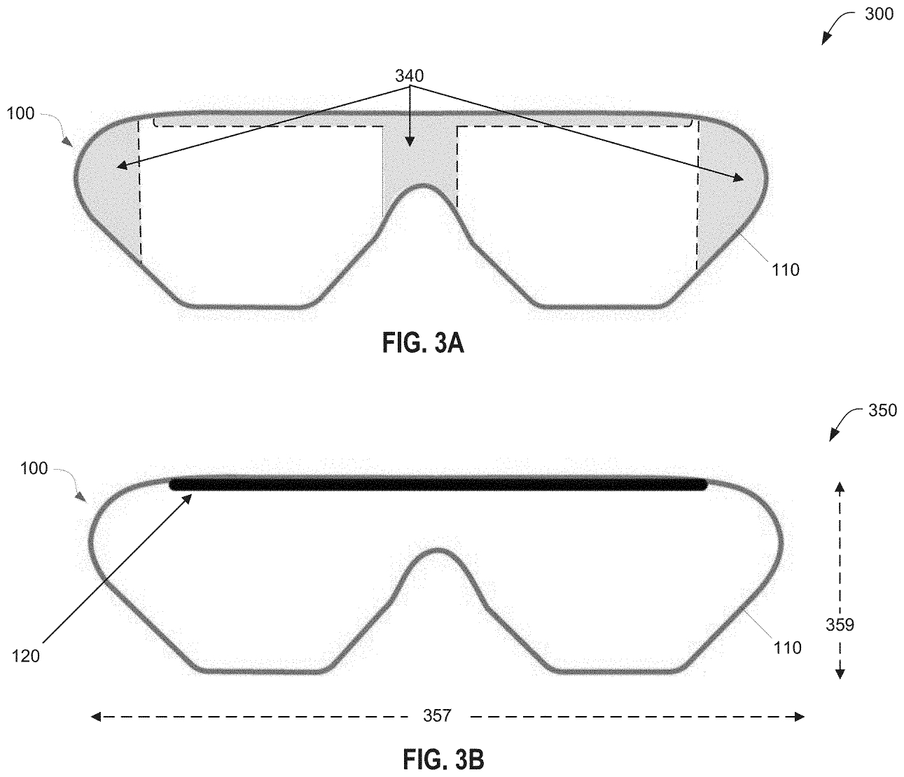

FIGS. 3A-3B are perspective views 300 and 350 of the eyewear device 100 of FIG. 1 in accordance with one embodiment of the disclosure. Here, the eyewear device 100 is shown straighten out and from different views, such as from the front and rear. As shown, the elongated body 110 and spring 120 are uncoiled with respect to the straight form state of the eyewear device 100. In this state, the spring 110 retains potential energy because of the relative position of spring 120 to the elongated body 110. This potential energy causes the spring 110 to coil immediately when the spring body is struck against an object such as a user's face.

In FIG. 3A, a rear view 300 of the eyewear device 100 is shown. In some embodiments, the eyewear device 100 may include one or more foam portions 340. The foam portions 340 may be constructed of a foam-like material. The foam material is arranged on the elongated body 110 so that the foam portions 340 are positioned between the user's face and the eyewear device 100 when worn. There are several advantages of the foam portions 340 that include, but not limited to, providing a degree of bias of the eyewear device 100 against the face of the user. This bias may provide a gap between the user and the eyewear device 100 for increased comfort. Another advantage of the foam portions 340 is to help provide a level of protection when the eyewear device 100 is applied to the user. Further, the foam portions 340 may help prevent the eyewear device 100 from slipping from the user's face when worn as well as other types of advantages.

In FIG. 3B, a front view 350 of the eyewear device 100 is shown. In some embodiments, the eyewear device 100 may be sized to fit around and overlap a user's face. For example, the elongated body 110 may be a determined length 357 and a determined width 359. In some embodiments, the length 357 and width 359 of elongated body 110 may be configured so that the eyewear device 100 can come in different shapes and sizes for different users, such as a small, medium and large. The thickness of the elongated body 110 may also vary while still allowing the eyewear device 100 to be coiled and uncoiled into a straighten state. In some embodiments, the state of the elongated body 110 may correspond to the state of the spring 120. For example as shown in FIG. 3B, when the elongated body 110 is in a substantially straight form so is the spring 120. As the elongated body 110 enters a coiled state so in turn is the spring 120 coiled.

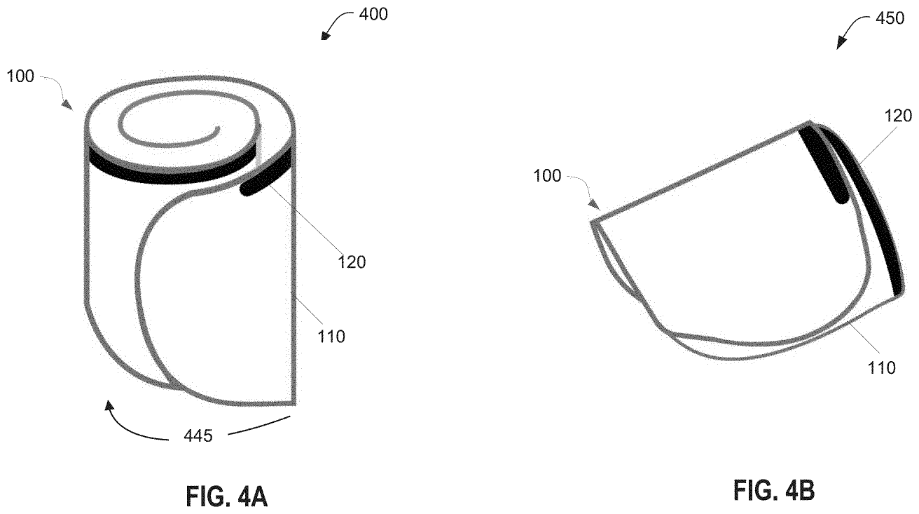

FIGS. 4A-4B depicts different views 400 and 450 of the eyewear device 100 of FIG. 1, for example, in a coiled state. In FIG. 4A, the eyewear device 100 is shown coiled and positioned straight up while FIG. 4B depicts the device 100 tilted to one side. The eyewear device 100 is preferable constructed of a flexible material, such as a layered polymer film, that is adapted to uncoil to match the expansion of the spring 120. When constructing the eyewear device 100, heat rollers are used to lower the plastic stiffness, which allows the spring 120 to coil the flexible material of the elongated body 110 more easily. The eyewear device 100 is then cooled into a final coiled shape. This process gives the eyewear device 100 the ability to roll up and to be secured to the user.

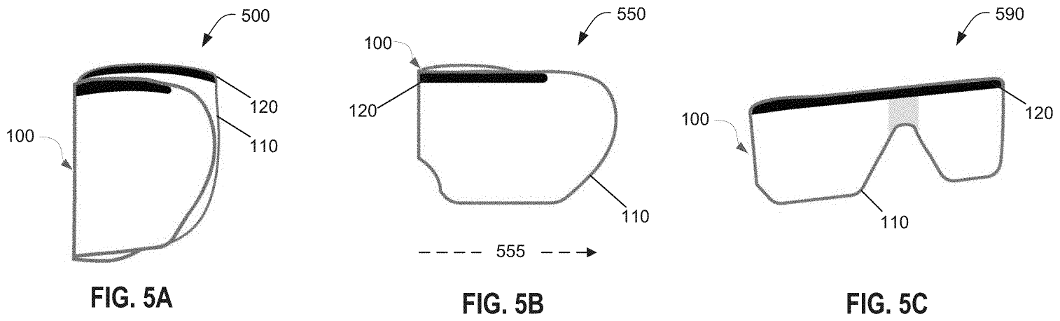

FIGS. 5A-5C depicts different states 500, 550 and 590 of the eyewear device 100 of FIG. 1 in accordance with one embodiment of the disclosure. For example, the elongated body 110 of the eyewear device 100 may have at least three states: a straighten state, a coiled state and a partially coiled state. In some embodiments, the state of the elongated body 110 may correspond to the state of the spring portion 120 of the eyewear device 100. For example, when the elongated body 110 is in a coiled state 500 as shown in FIG. 5A, so is the spring portion 120 of the device 100. With respect to FIG. 5B, the eyewear device 100 is shown being uncoiled in a certain direction as indicated by arrow 555. This is so that the elongated body 110 and the corresponding spring portion 120 may be laid out straight. In FIG. 5C, the eyewear device 100 is shown in a straighten state. In this state, the spring 120 retains potential energy because of the relative position of the spring body to the elongated body 110. This potential energy causes the spring 110 to coil immediately when the spring body is struck against an object such as a user's face.

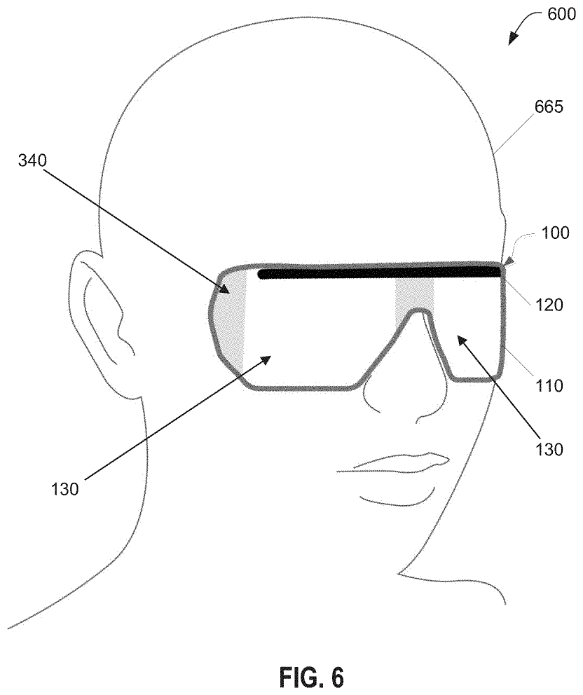

FIG. 6 depicts another state 600 of the eyewear device 100 of FIG. 1 in accordance with embodiments of the disclosure. In this example, the eyewear device 100 is shown in a partially coiled state 660. This example shows how the eyewear device 100 can stay secured on the face of a user 665. For example, when the eyewear device 100 is applied to the face of user 665, this causes the spring 120 to coil. The force of the spring 120 is constant enough to grant full head motion without slipping. The lens portions 130 are now positioned over the eyes of the user 665. For example, a first portion of the lens 130 may fit over a right eye of the user 665 while a second portion fits over the left eye. Further, the foam portions 340 of the eyewear device 100 lays against the face of the user 665 to provide an extra layer of protection, comfort and stability while the eyewear device 100 is being worn.

Reference throughout this specification to “one embodiment” or “an embodiment” means that a particular feature, structure, or characteristic described in connection with the embodiment is included in at least one embodiment of the disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An eyewear device comprising:
an elongated body comprising a spring portion and a lens portion disposed therein, the elongated body having at least three states: a straighten state, a coiled state and a partially coiled state,
wherein the spring portion is adapted to coil the elongated body and the lens portion is fixably attached to a user in response to the elongated body being in the partially coiled state.

2. The eyewear device of claim 1, wherein the spring portion, in response to being engaged, is configured to fixably attach the elongated body to the user.

3. The eyewear device of claim 1, wherein the elongated body is comprised of a flexible material.

4. The eyewear device of claim 3, wherein the flexible material is a plastic film.

5. The eyewear device of claim 1, wherein the spring portion is comprised of a semi-rigged material.

6. The eyewear device of claim 5, wherein in the semi-rigged material comprises a metal spring body.

7. The eyewear device of claim 6, wherein the semi-rigged material is adapted to transfer between forms comprising at least one of a straight form, a coiled form or a partially coiled form.

8. The eyewear device of claim 7, wherein each of the forms of the semi-rigged material of the spring portion corresponds to at least one of the states of the elongated body.

9. The eyewear device of claim 1, wherein the lens portion is comprised of a flexible material.

10. The eyewear device of claim 9, wherein the flexible material is a layered polymer.

11. The eyewear device of claim 1, wherein the lens portion is comprised of a visual adjustment layer.

12. The eyewear device of claim 11, wherein visual adjustment layer comprises a polarized lamination layer.

13. The eyewear device of claim 12, wherein a first portion of the polarized lamination layer is different than a second portion of the polarized lamination layer.

14. The eyewear device of claim 13, wherein the first portion is adapted to fit over a first eye of the user and the second portion is adapted to fit over a second eye of the user.

15. The eyewear device of claim 1, wherein the visual adjustment layer comprises an optically corrective layer.

16. The eyewear device of claim 15, wherein characteristics of optically corrective layer correspond to an optical prescription for the user.

17. The eyewear device of claim 1, wherein the visual adjustment layer comprises an optically protective layer to protect against ultra-violet light rays.

18. The eyewear device of claim 1, further comprising one or more foam portions coupled to the elongated body.

19. The eyewear device of claim 18, wherein the one or more foam portions are arranged to be disposed between portions of the elongated body and portions of the face of the user.

20. The eyewear device of claim 1, wherein the elongated body is attachable to the user by applying the spring portion in the straighten state to coil to a face of the user.
